(19) United States
(12) Patent Application Publication
(10) Pub. No.: US 2017/0183137 A1
(43) Pub. Date: Jun. 29, 2017

(54) PRESSURISED CONTAINER WITH PRESSURE RELIEF VALVE

(71) Applicant: PET ENGINEERING & SERVICES SRL, Calcinate (BG) (IT)

(72) Inventors: Philip Andrew WALTON, Durham (GB); Sergio SONZOGNI, Grassobbio (IT)

(21) Appl. No.: 15/301,453

(22) PCT Filed: Apr. 2, 2015
(86) PCT No.: PCT/GB2015/051051

§ 371 Date: Oct. 3, 2016

(30) Foreign Application Priority Data
Apr. 4, 2014 (GB) 1406185.7

(51) Int. Cl. B65D 77/22; B67D 1/12; B65D 85/72; B67D 1/04; B65D 51/16; B65D 77/06

(52) U.S. Cl. CPC B65D 77/225; B65D 51/1672; B65D 77/06; B65D 85/72; B67D 1/045; B67D 1/125; B67D 2001/0822

(57) ABSTRACT

A stretch blow moulded container such as a keg has a neck 3 fitted with a cap 4 to retain pressurised contents within the container. A miniature pressure relief valve (PRV) 30-33 is contained within the wall thickness of the neck to release gases on the occurrence of an overpressure event. The PRV may incorporate a bursting element, which renders the containers unusable, or a spring-loaded seal 30 which re-seals after the release of excess pressure. The PRV may also be permanently changed to an open condition by removal of the cap, preventing re-use of the container.

### TECHNICAL FIELD OF THE INVENTION

This invention relates to pressurised containers, and more particularly, stretch blow moulded (SBM) containers formed of thermoplastic polymers.

### BACKGROUND

SBM containers which contain beer, other pressurised liquids, or non-pressurised liquids which are dispensed under pressure are subject to significant internal pressures. The maximum pressure is usually stated on the container and should not be exceeded. If the pressure limit is exceeded a potentially dangerous bursting situation can occur. The internal pressure within the container is affected by several factors including the initial gas content, temperature, post-filling fermentation processes, connection to dispensing systems, etc. It is therefore desirable to incorporate a pressure relief valve (PRV) to prevent an excessive pressure rise.

SBM containers are created by stretching and blowing the body of a preformed thermoplastic parison, and in use, the body of the container may be subject to further deformations under pressure. It is therefore difficult to mount a PRV in the body of the container. The obvious place to mount the PRV is in the container closure, which is usually injection moulded and dimensionally stable, and at least one known container uses such an arrangement. However, due to space constraints and the need to avoid compromising the design of filling and emptying components built into the closure, the PRV has to be situated in such a position that it is more likely to vent liquid than gas. It is very desirable that the PRV vents gas rather than liquid during a potential overpressure condition because this more effectively reduces the pressure. Furthermore, venting gases also minimises the loss of valuable products and avoids inconvenience or potential dangers sometimes associated with liquid spillages.

It has also been proposed to provide the neck of a wine bottle with a plug which can be removed to de-pressurise the bottle so that the cork can be removed safely. (See FR339048-A, DE275688-C and FR2769297-A1.)

The present invention seeks to provide a new and inventive form of container which more effectively prevents an overpressure condition and which reduces the risk that liquid will be vented instead of gas.

### SUMMARY OF THE INVENTION

The present invention proposes a container according to claim 1.

Since the neck is not distorted during the blowing process it is possible to incorporate a PRV into this region without compromising the functioning of the closure. As long as the container is stored with its neck uppermost (which is generally the case) the internal gases will be vented in preference to any liquid contents.

The invention also provides a container having a closure and a pressure relief valve located within the closure.

The invention also provides a container having a neck and a pressure relief valve substantially contained within the wall thickness of the neck.

The invention also provides a container having a pressure relief valve housed in a recess in the wall of the neck.

The invention also provides a container having a neck and a recess which opens to the outside of the neck and a vent port between the recess and the interior of the neck.

The invention also provides a container having a pressure relief valve held in a recess by a retaining ring.

The invention also provides a container having a recess which is stepped outwardly adjacent to its outer end to receive a retaining ring.

The invention also provides a container having a pressure relief valve which includes a bursting element which ruptures in the event of an overpressure condition.

The invention also provides a container having a bursting element held against a ring seal which is held against a valve seat.

The invention also provides a container having a bursting element held against a ring seal by an annular seal carrier.

The invention also provides a container having a pressure relief valve which includes a sealing element which is spring-loaded against a valve seat.

The invention also provides a container having a sealing element held within a seal carrier.

The invention also provides a container having a pressure relief valve includes a compression spring which acts between a retaining ring and a seal carrier.

The invention also provides a container having a neck with a closure and a pressure relief valve which vents gas between the closure and the neck of the container.

The invention also provides a container having a neck and a closure which has internal screw threads which engage external screw threads on the neck of the container.

The invention also provides a container having a closure adapted to engage a pressure relief valve in such a way that removal of the closure opens the pressure relief valve to depressurise the container.

The invention also provides a container having a closure adapted to engage a retaining ring in such a way that the retaining ring is removed with the closure.

The invention also provides a container having a closure in which internal screw threads of the closure engage a projection on a retaining ring.

The invention also provides a container having a retaining ring with a spring projection.

The invention also provides a container having a closure with internal screw threads which incorporate a notch which engages a projection on a retaining ring.

The invention also provides a container having a closure with a notch having a ramp at one end and the opposite end of the notch has a stop.

The invention also provides a container having a closure which contains an access hole through which an instrument can be inserted to open a pressure relief valve.

The invention also provides a container having a closure with an access hole formed in a top wall of the closure.

The invention also provides a container which contains a flexible bag fillable through a fitting in a neck of the container, and the fitting is provided with a pressure relief valve to vent the bag into a space between the fitting and the neck of the container.

The invention also provides a container having a body which is formed by stretch blow moulding and a neck which incorporates a pressure relief valve.

### BRIEF DESCRIPTION OF THE DRAWINGS

The following description and the accompanying drawings referred to therein are included by way of non-limiting example in order to illustrate how the invention may be put into practice. In the drawings:

FIG. 1 is an axial section through a keg-type container in accordance with the invention;

FIG. 2 is an axial section through a parison which is used in manufacture of the keg;

FIG. 3 is an enlarged sectional detail of the neck of the keg, fitted with a cap, showing a first embodiment of the PRV in axial section;

FIG. 4 is another enlarged sectional detail of the neck and cap showing a second embodiment of the PRV;

FIG. 5 is a general external view of the neck showing a modification to the PRV;

FIG. 6 is a general internal view of a cap of the container which is intended for use with the modified PRV;

FIG. 7 is a general view, partly cut away, showing a modification to the cap for accessing the PRV;

FIG. 8 is a sectional view of the upper end of a bag-in-keg type container in accordance with the invention; and

FIG. 9 is a sectional view of another bag-in-keg type container fitted with a PRV in accordance with the invention.

### DETAILED DESCRIPTION OF THE DRAWINGS

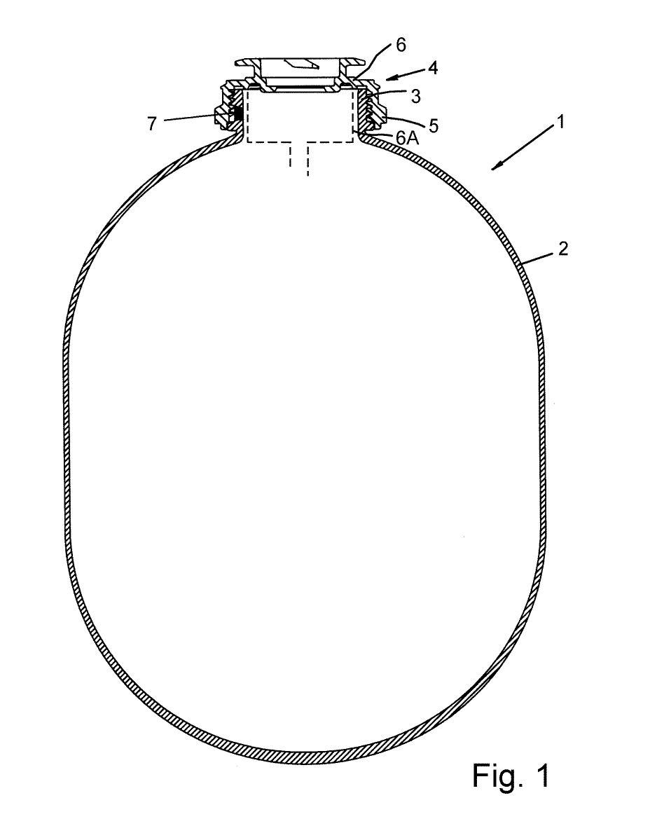

Referring firstly to FIG. 1, the keg 1 is of the type often used as a container for beer, fruit juices or other pressurised or non-pressurised liquids. The keg includes a hollow container body 2 having an integral neck 3 provided with a closure in the form of a cap 4. A top chime (not shown) may be secured to the upper part of the body 2 and the bottom of the container may be provided with a bottom chime (also not shown) or shaped to support the keg and engage the top chime of another keg during stacking—see WO 2012/066 303 A1 the contents of which are incorporated herein by reference. The cap 4 is injection moulded from a suitable thermoplastic polymer with a cylindrical side wall 5 and an end wall 6, and includes a fully recyclable valve arrangement 6A to permit filling and emptying the keg—see WO 2011/161 456 A1 the contents of which are also incorporated herein by reference. A pressure relief valve (PRV) 7 is mounted in the neck 3.

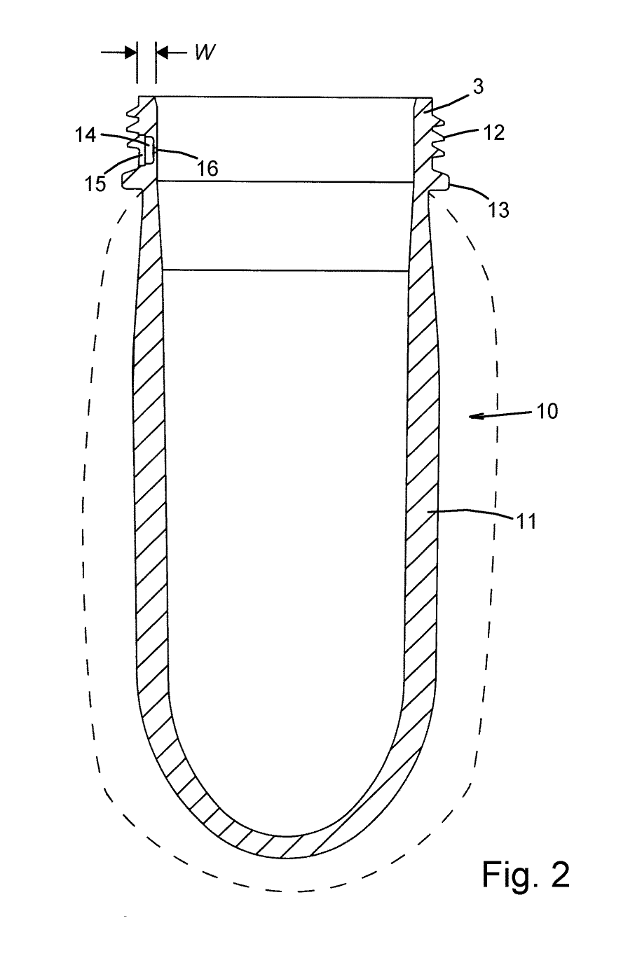

Referring to FIG. 2, the container body 2 and neck 3 are formed from a suitable thermoplastic polymer such as PET, starting with a preformed parison 10. An open end of the parison incorporates the neck 3 of the container, but the remaining body section 11 below the neck 3 is small and relatively thick-walled in relation to the container body. The neck 3 is of cylindrical shape with an external screw thread 12. A projecting external neck ring 13 separates the neck 3 from the body section 11. The wall of the neck 3 is of thickness W, and adjacent to the neck ring 13, contains a PRV housing comprising a circular recess 14 which is stepped to provide a entry section 15 of increased diameter. The bottom of the recess 14 communicates with the interior of the neck 3 via a port 16. The container is formed by stretch blow moulding (SBM), during which the body section 11 of the parison below the neck ring 13 is heated while air is blown into the parison so that the wall of section 11 expands and stretches, as indicated by the dashed lines, until, constrained by a suitable mould, it attains the final shape of the container. The size and shape of the neck 3 remains unchanged throughout the SBM process.

Before or after the SBM process a miniature pressure release valve (PRV) is mounted in the recess 14 entirely within the wall thickness of the neck 3. When the cap 4 is screwed onto the neck 3 the pressurised contents are sealed into the container by engagement of the top wall 6 of the cap with the opposing end face of the neck 3. If desired a sealing washer may be interposed between the cap and the end face of the neck 3. As is known in the art or pressurised containers, the threads are configured such that gases may bypass the threads once the seal is released so that there is no internal pressure as the cap is unscrewed.

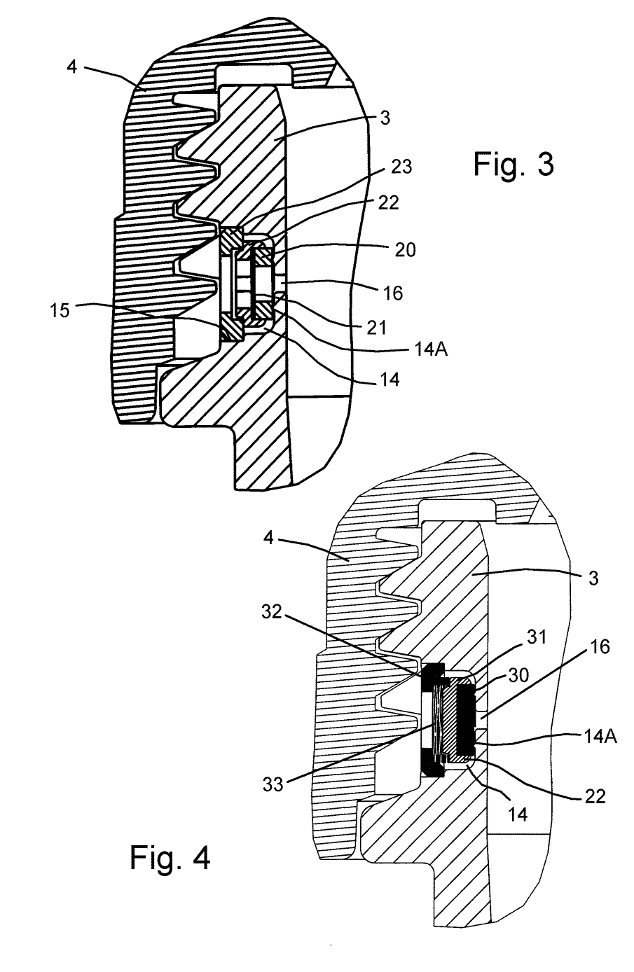

A simple form of single-use PRV is shown in FIG. 3, which also shows the cap 4 fitted to the neck 3 of the container. The PRV is mounted in the recess 14 substantially within the wall thickness W of the neck 3 and includes a ring seal 20 which forms a continuous seal against the bottom of the recess 14 surrounding the port 16, which constitutes a valve seat. A bursting disc 21 is sealingly held against the outer end of the ring seal 20 by an annular seal carrier 22, which is, in turn, held within the recess 14 by an outer retaining ring 23. The ring 23 may be secured in the entry section 15 by friction, although an adhesive, heat peening etc. could also be used. Under normal internal pressures the contents are sealed into the container, but an over pressure event will cause the bursting disc 21 to rupture allowing gas to escape through the port 16 via the interior of the seal 20, seal carrier 22 and retaining ring 23, exiting between the lower end of the cap 4 and the neck ring 13. With this form of PRV all internal pressure will be lost unrecoverably. This is intrinsically safe as one operation of the device will remove all risk of an overpressure condition, although the container becomes unusable after the event.

FIG. 4 shows a second embodiment of a suitable miniature PRV which re-seals the container after an overpressure event. Again the drawing shows the cap 4 fitted to the neck 3 of the container. This PRV is again mounted in the recess 14 within the wall thickness W of the neck 3 and includes a disc seal 30 which is mounted within a seal carrier 31 to form a continuous seal against the bottom of the recess 14 surrounding the port 16, which constitutes a valve seat. The seal carrier 22 is held within the recess 14 by an outer retaining ring 32. The ring 32 may be secured in the entry section 15 by friction, although an adhesive, heat peening etc. could also be used. A compression spring 33 acts between the retaining ring 32 and the seal carrier 31 so that the port 16 is sealingly closed by the seal 30. Under normal internal pressures the contents are sealed into the container, but an overpressure event causes the seal 30 to move away from the port 16 against the action of spring 33 allowing gas to escape through the port 16, around the seal carrier 31 and through the interior of the retaining ring 32, exiting between the lower end of the cap 4 and the neck ring 13. Such a spring return valve will relieve only the overpressure, which may be preferable if, for example, the over-pressurization was caused by post-fermentation as it would only vent excess gas during the fermentation process and still allow the contents to be used.

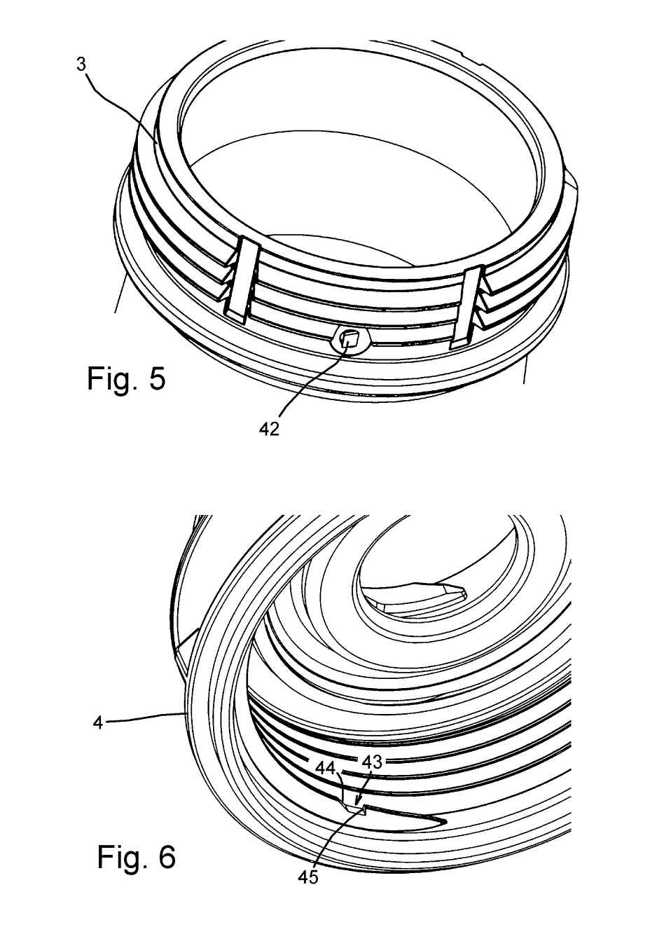

The neck-mounted PRV can also be used as an effective safety device to prevent refilling of the keg after the cap has been removed. FIG. 5 shows a modification in which the retaining ring of the PRV is formed with a spring tongue 42 which is inclined outwardly in the direction in which the cap 4 is screwed onto the neck 3. The internal screw threads of the cap 4 (FIG. 6) are formed with a co-operating notch 43. The trailing end of the notch, in the direction in which the cap is screwed onto the neck, is shaped to form an inclined ramp 44 whereas the opposite leading edge forms a stop 45. When the cap is screwed onto the neck 4 the ramp 44 enables the notch 43 to travel smoothly past the tongue 42 which is depressed inwards by the cap threads. If the cap is unscrewed however, the tongue 42 springs outwardly into the notch so that the outer end of the tongue engages the stop 45 causing the retaining ring to be pulled out of the neck. Once the retaining ring is dislodged the PRV is unable to seal against the port 16 so that the container can no longer be pressurised.

The locking ring and cap could have other configurations which similarly cause the locking ring to be removed and open the PRV whenever the cap is unscrewed.

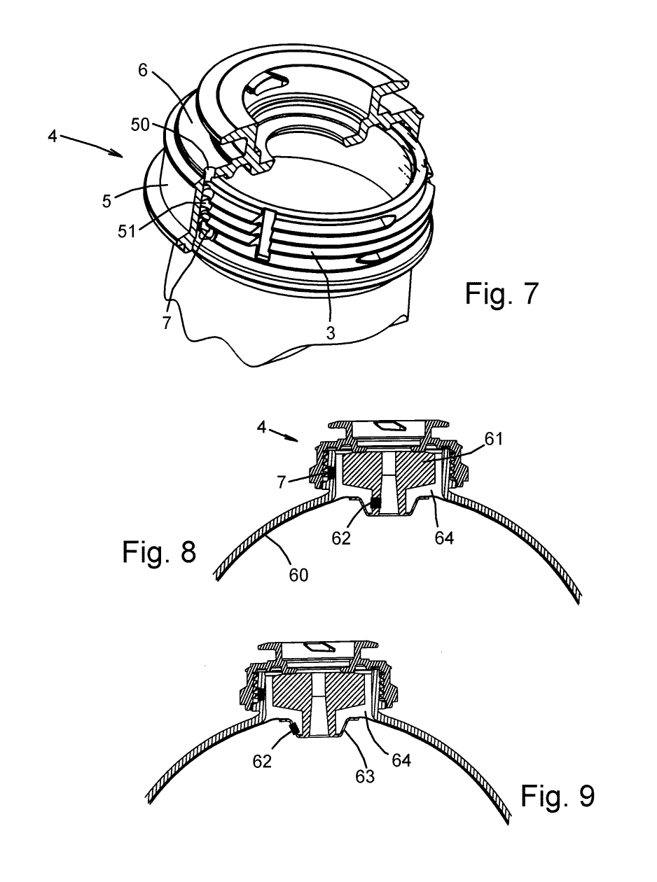

When a container has been emptied of liquid an overpressure condition is potentially more dangerous and for this reason users often prefer to completely depressurise containers after use. FIG. 7 shows an arrangement which enables a container to be manually depressurised without removing the cap. The top wall 6 of the cap 4 contains a small access hole 50 which enables a tool such as a screwdriver to be inserted between the neck 3 and the side wall 5 to gain access to the PRV 7 whereby the retaining ring can be destroyed to relieve the internal pressure. Access past the screw threads is obtained via aligned notches 51 (which may be the same notches that allow released gasses to bypass the threads as the cap is unscrewed).

The invention is also applicable to containers of the kind in which liquid is held inside the container within a flexible bag 60, as shown in FIG. 8. The neck may include an internal tubular fitting 61 through which liquid is withdrawn from the container assisted by gas pressure injected through the cap 4 into the space between the bag and the wall of the container body 2. In this case the gas space is vented via a PRV 7 mounted in the neck of the container as described, but an additional PRV 62 is mounted in the wall of the fitting 61 to vent internal pressure from inside the bag 60 via the fitting 61 into the internal gas space 64 between the fitting and the neck of the container. The additional PRV 62 could alternatively be positioned to vent the bag directly into the gas space by mounting it in an annular flange 63 at the bottom end of the fitting sealed to the mouth of the bag, as shown in FIG. 9.

Fitting the PRV from the outside of the container simplifies assembly although it would equally be possible to fit the PRV from inside the neck and vent the gases through an exit port.

Whilst the above description places emphasis on the areas which are believed to be new and addresses specific problems which have been identified, it is intended that the features disclosed herein may be used in any combination which is capable of providing a new and useful advance in the art.

1. A container (1) having a thermoplastic body (2) provided with a neck (3) fitted with a closure (6) which incorporates a dispensing valve (6A) and which is engaged with the neck to retain pressurised contents within the container,
characterised in that the neck (3) of the container incorporates a pressure relief valve (7).

2. A container according to claim 1 in which the pressure relief valve (7) is substantially contained within the wall thickness of the neck (3).

3. A container according to claim 1 in which the pressure relief valve (7) is housed in a recess (14) which opens to the outside of the neck and there is a vent port (16) between the recess and the interior of the neck.

4. A container according to claim 3 in which the pressure relief valve (7) is held in the recess (14) by a retaining ring (23, 32).

5. A container according to claim 4 in which the recess (14) is stepped outwardly (15) adjacent to its outer end to receive the retaining ring (23).

6. A container according to claim 1 in which the pressure relief valve (7) includes a bursting element (21) which ruptures in the event of an overpressure condition.

7. A container according to claim 6 in which the bursting element (21) is held against a ring seal (20) which is held against a valve seat (14A).

8. A container according to claim 7 in which the bursting element (21) is held against the ring seal (20) by an annular seal carrier (22).

9. A container according to claim 1 in which the pressure relief valve (7) includes a sealing element (30) which is spring-loaded (33) against a valve seat (14A).

10. A container according to claim 9 in which the sealing element (30) is held within a seal carrier (31).

11. A container according to claim 10 in which the pressure relief valve (7) includes a compression spring (33) which acts between a retaining ring (32) and the seal carrier (31).

12. A container according to claim 1 in which the closure (6) is adapted to engage the pressure relief valve (7) in such a way that removal of the closure opens the pressure relief valve to depressurise the container.

13. A container according to claim 1 in which the pressure relief valve (7) is held in a recess (14) by a retaining ring (23, 32) and the closure (6) is adapted to engage the retaining ring in such a way that the retaining ring is removed with the closure.

14. A container according to claim 1 in which the pressure relief valve (7) is located within the closure (4) and the closure contains an access hole (50) through which an instrument can be inserted to open the pressure relief valve.

15. A container according to claim 1 which contains a flexible bag (60) fillable through a fitting (61) in the neck of the container, and the fitting is provided with an additional pressure relief valve (62) to vent the bag into a space (64) between the fitting and the neck of the container.
